(19) United States
(12) Patent Application Publication
(10) Pub. No.: US 2020/0339725 A1
(43) Pub. Date: Oct. 29, 2020

(54) POLYURETHANE COMPRISING FORMULATIONS WITH ISOCYANATE

(71) Applicant: Huntsman International LLC, The Woodlands, TX (US)

(72) Inventors: Servaas Holvoet, Veltem-Beisem (BE); Andreas Rits, (BE); Nicole Mangelschots, Wilsele (BE); Machteld Beyens, Everberg (BE)

(21) Appl. No.: 16/958,271

(22) PCT Filed: Jan. 10, 2019
(86) PCT No.: PCT/EP2019/050498

§ 371 Date: Jun. 26, 2020

(30) Foreign Application Priority Data
Jan. 10, 2018 (EP) 18151001.7

(51) Int. Cl. C08G 18/10; C08G 18/42; C08G 18/78; C08G 18/76; C08G 18/48; C08G 18/28; C08G 18/22

(52) U.S. Cl. CPC C08G 18/10; C08G 18/42; C08G 18/7837; C08G 18/222; C08G 18/485; C08G 18/283; C08G 18/7671

(57) ABSTRACT

A urethane group-containing reactive polyisocyanate composition is disclosed which contains not more than 1 wt % of monomeric starting di-isocyanate based on the total weight of said polyisocyanate composition, having an NCO value in the range 0.1-15%, and wherein said composition comprises urethane groups and allophanate groups and wherein the ratio of allophanate groups over urethane groups is between 0.05 and 100.

### FIELD OF INVENTION

The present invention is related to polyurethane comprising formulations with isocyanate functionality and low monomer content, more in particular low di-isocyanate monomer content.

Further the present invention is related to a process for preparing said polyurethane comprising formulations with isocyanate functionality and low monomer content.

Still further the present invention is concerned with the use of the polyurethane comprising formulations with isocyanate functionality and low monomer content in coating, adhesive and sealant applications.

### BACKGROUND

Residual monomer contents in polyisocyanates and polyurethane systems can be disadvantageous for different reasons. Some systems are processed at elevated temperatures (e.g. hot melt adhesives at 100-170° C.), a temperature range at which monomeric di-isocyanates have a considerable vapour pressure.

Furthermore, PU systems comprising 1% or more free MDI are classified and labelled since Dec. 1, 2010 either according to the DSD (dangerous Substances Directive from the European Union) with R40 (wherein R40 is labelled as limited evidence of a carcinogenic effect) or according to the CLP (Classification, Labelling and Packaging regulation from the European Union) with H351. The implications of the reclassification affect the consumer use in Germany, France, Austria etc. since they impose consumer access control to products containing substances classified H351 (e.g. training shop staff, locked cupboards, log book of recipient, etc.). This reclassification applies to di-isocyanate species or preparations/mixtures containing more than 1% of monomeric di-isocyanates. Many PU systems contain high concentrations of the MDI monomer (e.g. OCF cans), and are thus classified as potentially carcinogenic.

In addition, the German Federal Institute for Occupational Safety and Health (BAuA) is recently proposing a risk-based measure under the REACH regulation for the industrial and professional use of di-isocyanates. The proposal prohibits the sale and use of all di-isocyanates-based products that contain >0.1% by weight di-isocyanate (unless it can be demonstrated that a product/use combination leads to acceptable residual dermal and inhalation exposure only or unless workers and management received training in combination with workplace technical & organizational measures).

A possible way to reduce the amount of monomer (di-isocyanate) concentration is to strip off the volatile isocyanate monomers from the prepolymer systems using a distillation technique (e.g. thin film evaporator). This is disclosed in EP0316738 and U.S. Pat. No. 5,441,808. Stripping requires however an extra unit operation and therefore adds capital costs and operation costs to the production of the prepolymers. Additionally, the viscosity of the resulting polymeric will be so high it cannot be handled without heating.

Another possibility for reducing the monomer content involves preparing prepolymers using the selective reactivity of asymmetric di-isocyanates (WO0300652A1).

Another possibility is by viscosity control through use of (mixtures) of monools/diols/triols (US20060079661A1, U.S. Pat. No. 5,880,167A1).

Other routes to low monomer systems include for example lowering the NCO/OH ratio during prepolymer synthesis such that lower monomer containing prepolymers are obtained. Reducing the NCO/OH ratio is however impracticable as the average Mw increases exponentially, and the resulting PU compositions would have extremely high viscosities and could no longer be applied.

One other effective way of eliminating the monomer is the use of hybrids in which the isocyanates are fully tipped (end capped) with an alternative functionality. This approach enables to make isocyanate free (and so monomer free) materials e.g. tipping with alkoxysilanes (EP1245601A1) or e.g. tipping with acrylates (EP1247825A1). Complete tipping of isocyanates with tipping agents might also lead to very high viscosities (>150 Pas which make them not suitable for several PU applications) and high cost.

Still another approach is the use of blocked isocyanates. The isocyanate is (fully) converted into a blocked analogue (e.g. oximes, phenolics etc.) and the blocking agent is removed during cure, generating the isocyanate in situ. A special case of blocked isocyanates is dimerized MDI. Disadvantages of blocked isocyanates is the need for deblocking temperatures (can easily exceed 100-150° C.), the broad temperature range for complete deblocking and the release of the blocking agent which thereafter can yield EHS (VOC emission) issues.

Another approach is the chemical fixing of the monomeric isocyanate by partial trimerization of the isocyanate (Frisch et al, Advance in Urethane Science and Techn., vol. 1-7, 1971-1979). Partial trimerization however requires the use of viscosity reducing agents (solvents, plasticizers etc.).

Solvent extractions are used as well to extract some of the monomer from the prepolymer system.

Despite the many approaches to lower the monomer concentration in polyurethane comprising prepolymers, there is still need for further improvement and a further need to further develop ways to achieve low monomeric systems.

### SUMMARY OF THE INVENTION

According to a first aspect of the invention, a urethane group-containing reactive polyisocyanate composition is disclosed which contains not more than 1 wt % of monomeric starting di-isocyanate based on the total weight of said polyisocyanate composition, having an NCO value in the range 0.1-15%, and wherein said composition comprises urethane groups and allophanate groups and wherein the ratio of allophanate groups over urethane groups is between 0.05 and 100.

According to embodiments, the amount of monomeric starting di-isocyanate molecules in the reactive polyisocyanate composition is preferably below 0.5 wt %, most preferably below 0.1 wt % based on the total weight of said polyisocyanate composition.

According to embodiments, the NCO value of the reactive polyisocyanate composition is in the range 0.8-2%, preferably in the range 1-2%, most preferably the NCO value is around 1%.

According to embodiments, the ratio allophanate groups over urethane groups in the reactive polyisocyanate composition is larger than 0.1, preferably larger than 1.

According to a second aspect of the invention, a method to prepare the reactive polyisocyanate composition according to the first aspect of the invention is disclosed, said method comprising mixing at least following compounds:
An allophanate based polyisocyanate intermediate prepolymer containing ≥0.1 wt % and ≤25 wt % of monomeric di-isocyanate compounds based on the total weight of said prepolymer and having an NCO value in the range 5-15%, and
An isocyanate reactive composition containing isocyanate reactive compounds having a functionality between 1 and 10 and a molecular weight in the range 100-10000, and
Wherein the allophanate based polyisocyanate intermediate prepolymer is the reaction product of at least one polyisocyanate compound and an isocyanate reactive compound selected from a monool having a molecular weight in the range 32-2000 g/mol, preferably 36-2000 g/mol, and wherein the ratio of allophanate groups over the urethane groups is higher than 0.05.

As explained above, the amount of monomeric starting di-isocyanate molecules in the final reactive polyisocyanate composition is not more than 1 wt %, based on the total weight of said polyisocyanate composition.

According to embodiments, the allophanate based polyisocyanate intermediate prepolymer contains ≥5 wt % and ≤20 wt %, preferably ≥8 wt % and ≤15 wt % monomeric starting di-isocyanate compounds based on the total weight of said prepolymer.

According to embodiments, the ratio of allophanate groups over the urethane groups in the allophanate based polyisocyanate intermediate prepolymer is in the range 1-100.

According to embodiments, the allophanate based polyisocyanate intermediate prepolymer has an NCO value in the range 8-12%.

According to embodiments, the monools are selected from polyoxyalkylene polyether monools, polyester monools and modified castor oil monools, having an average molecular weight of 32-1000 g/mol, preferably 100-1000 g/mol, more preferably 250-750 g/mol. Using monools with low molecular weight (32-1000 g/mol, preferably 250-750 g/mol) is advantageous and enables forming an intermediate prepolymer that, when further reacted with isocyanate reactive composition having a molecular weight in the range 100-10000, will contribute to reach a low amount of monomeric starting di-isocyanate molecules in the final composition (below 0.5 wt %, based on the total weight of the final composition).

According to embodiments, the polyisocyanate compounds used to make the polyisocyanate intermediate prepolymer are selected from diphenylmethane diisocyanate (MDI) based polyisocyanates having <40 wt % 2,4 MDI calculated on the total weight of the organic polyisocyanate mixture.

According to embodiments, the isocyanate reactive compounds used to react with the allophanate intermediate prepolymer is having a functionality between 1.8 and 10, preferably between preferably 2 to 4.

According to embodiments, the isocyanate reactive compounds used to react with the allophanate intermediate prepolymer are selected from the group comprising polyethers, polyesters, acrylic polyols, castor oil and modified castor oils, polybutadiene, polyolefin, preferably selected from polyester polyols.

According to a third aspect of the invention, an allophanate based polyisocyanate intermediate prepolymer suitable for making the urethane group-containing polyisocyanate composition according to the first aspect of the invention is disclosed, said intermediate prepolymer is the reaction product of at least one polyisocyanate compound and at least one isocyanate reactive compound selected from a monool having a molecular weight in the range 32-2000 g/mol, preferably 36-2000 g/mol, and having following characteristics:
Containing ≥0.1 wt % and ≤25 wt %, preferably ≥5 wt % and ≤20 wt % monomeric di-isocyanate compounds based on the total weight of said prepolymer, and
Having an NCO value in the range 5-15%, preferably in the range 8-12%, and
Having a ratio of allophanate groups over urethane groups higher than 0.05 and preferably in the range 1-100.

According to a fourth aspect of the invention, the use of the urethane group-containing polyisocyanate composition according to the first aspect of the invention is disclosed for making sealants, coatings, adhesives, elastomers.

The independent and dependent claims set out particular and preferred features of the invention. Features from the dependent claims may be combined with features of the independent or other dependent claims as appropriate.

The above and other characteristics, features and advantages of the present invention will become apparent from the following detailed description. This description is given for the sake of example only, without limiting the scope of the invention.

### Definitions and Terms

In the context of the present invention the following terms have the following meaning:
1) “isocyanate index” or NCO index or index:
   the ratio of NCO-groups over isocyanate-reactive hydrogen atoms present in a formulation, given as a percentage:

### [NCO]×100(%).

[active hydrogen]

In other words, the NCO-index expresses the percentage of isocyanate actually used in a formulation with respect to the amount of isocyanate theoretically required for reacting with the amount of isocyanate-reactive hydrogen used in a formulation.

It should be observed that the isocyanate index as used herein is considered from the point of view of the actual polymerisation process preparing the material involving the isocyanate ingredient and the isocyanate-reactive ingredients. Any isocyanate groups consumed in a preliminary step to produce modified polyisocyanates (including such isocyanate-derivatives referred to in the art as prepolymers) or any active hydrogens consumed in a preliminary step (e.g. reacted with isocyanate to produce modified polyols or polyamines) are not taken into account in the calculation of the isocyanate index. Only the free isocyanate groups and the free isocyanate-reactive hydrogens (including those of water, if used) present at the actual polymerisation stage are taken into account.
2) The expression “isocyanate-reactive compounds” and “isocyanate-reactive hydrogen atoms” as used herein for the purpose of calculating the isocyanate index refers to the total of active hydrogen atoms in hydroxyl and amine groups present in the isocyanate reactive compounds; this means that for the purpose of calculating the isocyanate index at the actual polymerisation process one hydroxyl group is considered to comprise one reactive hydrogen, one primary amine group is considered to comprise one reactive hydrogen and one water molecule is considered to comprise two active hydrogens.
3) The term “average nominal hydroxyl functionality” (or in short “functionality”) is used herein to indicate the number average functionality (number of hydroxyl groups per molecule) of the polyol or polyol composition on the assumption that this is the number average functionality (number of active hydrogen atoms per molecule) of the initiator(s) used in their preparation although in practice it will often be somewhat less because of some terminal unsaturation.
4) The word “average” refers to number average unless indicated otherwise.
5) A “urethane group-containing polyisocyanate composition” refers to a composition wherein the polyisocyanate is partly reacted with isocyanate reactive compounds to achieve urethane groups (often also referred to as a polyisocyanate prepolymer).
6) A “urethane group-containing reactive polyisocyanate composition according to the invention” refers to a urethane group-containing polyisocyanate composition (prepolymer) which comprises beside urethane groups also allophanate groups. The word reactive refers to remaining isocyanate (NCO) functionality.
7) An “allophanate based intermediate polyisocyanate prepolymer” or “allophanate based prepolymer” refers in this invention to a polyisocyanate prepolymer comprising urethane groups and allophanate groups. The allophanate based polyisocyanate prepolymer is obtained by partly reacting the polyisocyanates with isocyanate reactive compounds to achieve urethane groups and further reacting the obtained urethane groups with polyisocyanates to form allophanate groups. The NCO value of the allophanate based polyisocyanate prepolymer in this invention is between 5 and 15%.
8) In the context of the present invention, the expression “NCO content” should be understood as the NCO value, which is defined as:
   The isocyanate content (NCOv) (also referred to as percent NCO or NCO content) of all prepolymers, given in weight %, was measured by conventional NCO titration following the standard DIN 53185. In brief, isocyanate is reacted with an excess of di-n-butylamine to form urea. The unreacted amine is then titrated with standard nitric acid to the color change of bromocresol green indicator or to a potentiometric endpoint. The percent NCO or NCO-value is defined as the percent by weight of NCO-groups present in the product.
   In the context of the present invention, the expression “NCO value” corresponds to an isocyanate value (also referred as isocyanate content or NCO content), which is the weight percentage of reactive isocyanate (NCO) groups in an isocyanate containing compound, modified isocyanate or prepolymer and is determined using the following equation, where the molecular weight of the NCO group is 42:

Isocyanate value=% NCO groups=(42×Functionality)/(Molecular weight)×100.

### DETAILED DESCRIPTION

The present invention will be described with respect to particular embodiments.

It is to be noticed that the term “comprising”, used in the claims, should not be interpreted as being restricted to the means listed thereafter; it does not exclude other elements or steps. It is thus to be interpreted as specifying the presence of the stated features, steps or components as referred to, but does not preclude the presence or addition of one or more other features, steps or components, or groups thereof. Thus, the scope of the expression “a device comprising means A and B” should not be limited to devices consisting only of components A and B. It means that with respect to the present invention, the only relevant components of the device are A and B.

Throughout this specification, reference to “one embodiment” or “an embodiment” are made. Such references indicate that a particular feature, described in relation to the embodiment is included in at least one embodiment of the present invention. Thus, appearances of the phrases “in one embodiment” or “in an embodiment” in various places throughout this specification are not necessarily all referring to the same embodiment, though they could. Furthermore, the particular features or characteristics may be combined in any suitable manner in one or more embodiments, as would be apparent to one of ordinary skilled in the art.

It is to be understood that although preferred embodiments and/or materials have been discussed for providing embodiments according to the present invention, various modifications or changes may be made without departing from the scope and spirit of this invention.

The present invention relates to a urethane group-containing polyisocyanate composition (also referred to as a 1 component isocyanate prepolymer) which has an NCO value below 15 and contains not more than 1 wt % of monomeric starting di-isocyanate based on the weight of said polyisocyanate composition. Further the invention relates to a process for making the polyisocyanate composition and the intermediate allophanate based polyisocyanate prepolymers and polyol composition required to make the urethane group-containing polyisocyanate composition according to the invention. Furthermore, the invention relates to the use of the urethane group-containing polyisocyanate composition according to the invention in adhesive and coating applications.

According to a first aspect of the invention, a urethane group-containing reactive polyisocyanate composition which contains not more than 1 wt % of monomeric (starting) di-isocyanate molecules based on the total weight of said polyisocyanate composition and having an NCO value in the range 0.1-15% is disclosed. Said urethane group-containing polyisocyanate composition is containing urethane groups and allophanate groups and has a ratio of allophanate groups over urethane groups larger than 0.05 and below 100.

According to embodiments the amount of monomeric starting di-isocyanate molecules in the urethane group-containing polyisocyanate composition of the invention is preferably below 0.5 wt %, most preferably below 0.1 wt % monomeric starting di-isocyanate molecules based on the total weight of said polyisocyanate composition.

According to embodiments, the NCO value in the urethane group-containing polyisocyanate composition of the invention is preferably in the range 0.8-2%, preferably in the range 1-2%, most preferably the NCO value is around 1%, for example the NCO value may be 0.9%, 1%, 1.1%, 1.2%.

According to embodiments, the ratio allophanate groups over urethane groups is below 100 and larger than 0.05, preferably larger than 0.1, preferably larger than 1.

According to a second aspect a method is disclosed to prepare the urethane group-containing polyisocyanate composition according to the present invention. Said method comprising mixing at least following compounds:
An allophanate based polyisocyanate intermediate prepolymer containing ≥0.1 wt % and ≤25 wt % of monomeric starting di-isocyanate compounds based on the total weight of said prepolymer and having an NCO value in the range 5-15%, and
An isocyanate reactive composition containing isocyanate reactive compounds having a functionality between 1.8 and 10, and
Wherein the allophanate based polyisocyanate intermediate prepolymer is the reaction product of at least one polyisocyanate compound and an isocyanate reactive compound selected from a monool having a molecular weight in the range 32-2000 g/mol, preferably 36-2000 g/mol and wherein the ratio of allophanate groups over the urethane groups is larger than 0.05, preferably in the range 1-100.

According to preferred embodiments, the allophanate based polyisocyanate intermediate prepolymer contains ≥5 wt % and ≤20 wt % of monomeric starting di-isocyanate compounds based on the total weight of said prepolymer. Most preferred the wt % of monomeric starting di-isocyanate is in the range 8-15 wt % based on the total weight of said prepolymer.

According to preferred embodiments, the allophanate based polyisocyanate intermediate prepolymer has an NCO value in the range 8-12%.

Allophanates are typically formed at elevated temperatures (higher than 100° C.) or in the presence of special catalysts at lower temperatures by a reaction between urethane groups and isocyanate groups to form allophanate linkages:

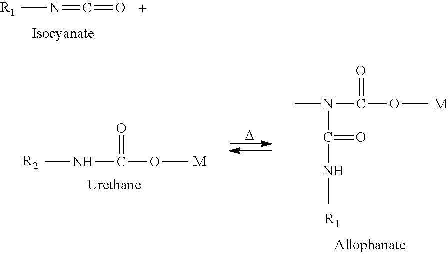

Wherein R₁ and R₂ represent a rest group or any other isocyanate molecule and M is representing in this invention a monool.

Suitable polyisocyanates comprise polyisocyanates of the type R—(NCO)ₓ with x being at least 1 and R being an aromatic or aliphatic group, such as diphenylmethane, toluene, dicyclohexylmethane, hexamethylene, or a similar polyisocyanate. Preferably, said polyisocyanate comprises at least two isocyanate groups.

Non-limiting examples of suitable organic polyisocyanates which may be used in the present invention include aliphatic isocyanates such as hexamethylene diisocyanate; and aromatic isocyanates such as diphenylmethane diisocyanate (MDI), in the form of mixtures of its 2,4′-, 2,2′- and 4,4′-isomers and mixtures of diphenylmethane diisocyanates (MDI) and oligomers thereof, as well as polymeric methylene diphenyl diisocyanate (pMDI), m- and p-phenylene diisocyanate, tolylene-2,4- and tolylene-2,6-diisocyanate (also known as toluene diisocyanate, and referred to as TDI, such as 2,4 TDI and 2,6 TDI) in any suitable isomer mixture, chlorophenylene-2,4-diisocyanate, naphthylene-1,5-diisocyanate, diphenylene-4,4′-diisocyanate, 4,4′-diisocyanate-3,3′-dimethyl-diphenyl, 3-methyl-diphenylmethane-4,4′-diisocyanate and diphenyl ether diisocyanate; and cycloaliphatic diisocyanates such as cyclohexane-2,4- and -2,3-diisocyanate, 1-methylcyclohexyl-2,4- and -2,6-diisocyanate and mixtures thereof and bis-(isocyanatocyclohexyl)methane (e.g. 4,4′-diisocyanatodicyclohexylmethane (H12MDI)), triisocyanates such as 2,4,6-triisocyanatotoluene and 2,4,4-triisocyanatodiphenylether, isophorone diisocyanate (IPDI), butylene diisocyanate, trimethylhexamethylene diisocyanate, isocyanatomethyl-1,8-octane diisocyanate, tetramethylxylene diisocyanate (TMXDI), 1,4-cyclohexanediisocyanate (CDI), and tolidine diisocyanate (TODI); any suitable mixture of these polyisocyanates.

Suitable catalysts for initiating the formation of allophanates are for example Zn-neodecanoate, commercially available as Valikat® Zn1910 from Umicore and alkylacetoacetate based catalysts such as Zn-acetylacetonate or any suitable catalyst capable of forming allophanate linkages in polyisocyanates.

Catalyst deactivators to be used in the invention include acidic materials such as thionyl chloride. Generally, catalyst stoppers are added in a ratio of at least 1 equivalent of deactivator to each mole of the allophanate catalyst, e.g. Zn-acetylacetonate.

According to embodiments, the monools suitable for making the allophanate based polyisocyanate intermediate prepolymer of the invention may be selected from polyoxyalkylene polyether monools which may be prepared by the simple addition of one or more alkylene oxides to an initiator fatty hydrocarbon having one alkylene oxide active hydrogen represented by the general formula R—X where R represents a C8-C24 branched or unbranched, saturated or ethylenically unsaturated, aliphatic or alicyclic radical; preferably an aliphatic linear, saturated or ethylenically unsaturated radical; more preferably a linear alkyl (saturated) radical, and most preferably a linear C12-C15 alkyl radical; and X represents OH, NRH, or SH, preferably OH.

According to embodiments, the monools suitable for making the allophanate based polyisocyanate intermediate prepolymer of the invention may be selected from methanol, ethanol, propanol, butanol, phenol, cyclohexanol and hydrocarbon monools having an average molecular weight in the range 32-2000 g/mol, preferably 36-2000 g/mol, more preferably 32-1000 g/mol, even more preferably 100-1000 g/mol, and advantageously 250-750 g/mol, such as aliphatic monools, polyether monools, polyester monools and modified castor oil monools. A preferred example of a suitable polyether monool is poly(ethylene glycol) methyl ether.

According to embodiments, the polyisocyanate compounds used in the urethane group-containing polyisocyanate composition according to the present invention are selected from organic isocyanates containing a plurality of isocyanate groups including aliphatic, cycloaliphatic and/or araliphatic polyisocyanates, preferably diphenylmethane diisocyanate (MDI) based polyisocyanates, preferably diphenylmethane diisocyanate (MDI) based polyisocyanates having <50 wt % 2,4 MDI, most preferably diphenylmethane diisocyanate (MDI) based polyisocyanates having <40 wt % 2,4 MDI calculated on the total weight of the organic polyisocyanate mixture. Advantageously, it has been observed that using diphenylmethane diisocyanate (MDI) based polyisocyanates containing 2,4 MDI at a content ranging from 10 to 40 wt % is preferred, based on the total weight of the organic polyisocyanate mixture.

Methylene bridged polyphenyl polyisocyanates (e.g. Methylene diphenyl diisocyanate, abbreviated as MDI) are well known in the art and have the generic formula I wherein n is one or more and in the case of the crude mixtures represents an average of more than one. They are prepared by phosgenation of corresponding mixtures of polyamines obtained by condensation of aniline and formaldehyde.

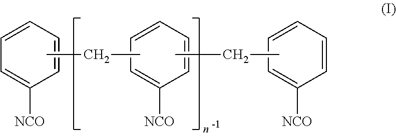

According to embodiments, the isocyanate reactive compounds used to react with the allophanate intermediate prepolymer (in order to make the urethane group-containing polyisocyanate composition according to the present invention) have a functionality between 1 and 10, preferably between preferably 2 to 4.

According to embodiments, the isocyanate reactive compounds used to react with the allophanate intermediate prepolymer have an average molecular weight in the range 100-10000 g/mol, preferably 500-5000 g/mol.

According to embodiments, the isocyanate reactive compounds used to react with the allophanate intermediate prepolymer (in order to make the urethane group-containing polyisocyanate composition according to the present invention) are selected from the group comprising polyethers, polyesters, acrylic polyols, polycarbonates, castor oil and modified castor oils, polybutadienes, polyolefines. Examples of suitable isocyanate reactive compounds are polyester polyols such as Hoopol® F1390 or Hoopol® F931 (polyester polyols from Synthesia).

According to a third aspect of the invention, an allophanate based polyisocyanate intermediate prepolymer suitable for making the urethane group-containing reactive polyisocyanate composition according to the present invention is disclosed. Said allophanate based polyisocyanate intermediate prepolymer is the reaction product of at least one polyisocyanate compound and at least one isocyanate reactive compound selected from a monool having a molecular weight in the range 32-2000 g/mol, preferably 36-2000 g/mol, more preferably 32-1000 g/mol, even more preferably 100-1000 g/mol, and advantageously 250-750 g/mol and having following characteristics:
Containing ≥0.1 wt % and ≤25 wt %, preferably ≥5 wt % and ≤20 wt %, more preferably ≥8 wt % and ≤15 wt % monomeric di-isocyanate compounds based on the total weight of said prepolymer, and
Having an NCO value in the range 5-15%, preferably in the range 8-12%, and
Having a ratio of allophanate groups over urethane groups higher than 0.05, preferably in the range 1-100.

The allophanate based polyisocyanate intermediate prepolymer is made by at least one polyisocyanate compound and at least one isocyanate reactive compound selected from a monool thereby using a specific allophanate forming catalyst at temperatures (cook temperature) below 120° C., preferably <110° C. and most preferred <100° C.

According to a fourth aspect, the use of the urethane group-containing polyisocyanate composition of the present invention is disclosed (also referred to commercially as 1 component PU systems) for making sealants, coatings, adhesives.

According to embodiments, the urethane group-containing polyisocyanate composition of the present invention may be applied by means of spraying after the required ingredients were mixed at the departure point from a spray nozzle, by dispensing, by roller or by brush application.

The invention is now illustrated with below reference to the examples. The examples are given for the sake of example only, without limiting the scope of the invention.

### Examples

Chemicals Used:
Hoopol® F-931: Polyester polyol from Synthesia (OH value: 37-40 mgKOH/g)
Suprasec® 1306 from Huntsman (pure 4,4′ MDI, NCO value 33.6%)
Suprasec® 2008 from Huntsman (prepolymer from MDI and polyether polyol, NCO value 10.2%)
Suprasec® 3030 from Huntsman (mix from 60-65% 4,4′ MDI and 35-40% 2.4 MDI, NCO value 33.6%)
Daltocel® XF460 from Huntsman (polyether polyol, Mw˜4000, OHv 30, f 1.8, PO-EO tipped)
MPEG500 from Ineos, Poly(ethylene glycol) methyl ether with average molecular weight of 500 g/mol used as monool
Valikat Zn1910 from Umicore, zinc neodecanoate: an allophanate initiating catalyst
Zn-acetylacetonate from Aldrich, an allophanate initiating catalyst
Thionyl chloride from Aldrich, a catalyst deactivator.

The NCO content of all prepolymers was determined by titration according to DIN 53185. The MDI monomeric content (di-isocyanate) was determined by GPC (determination di-isocyanate) combined with GC-MS (correction 4,4′/2,4′). The degree of allophanation was determined by 13C NMR.

In the following examples, the urethane group-containing polyisocyanate composition is referred to as a reactive hot melt composition (RHM). The reactive hot melt composition made according to the invention are resulting in compositions having <1.0 wt % monomeric di-isocyanate.

### 1) Comparative Example: Reactive Hot Melt (RHM) Based on Pure MDI

Suprasec® 1306 (pure MDI) was prepolymerized with Hoopol® F931 to an NCO value of 3.0%.

85.6 g Hoopol® F931 was dried under vacuum at 100° C. and after cooling to 80° C., weighted into a reaction flask under nitrogen atmosphere. 14.4 g Suprasec® 1306 was added while blanketing with nitrogen and stirring vigorously. Temperature was maintained for 1.5 hours until a NCO value of 3.0% was reached with a monomeric di-isocyanate content of 4.6%.

Conclusion: the RHM based on pure MDI (100% di-isocyanate) did not enable to achieve a monomeric di-isocyanate content <1.0%.

### 2) Comparative Example: Reactive Hot Melt (RHM) Based on Suprasec® 2008

Suprasec® 2008 (a prepolymer from MDI and polyether polyol, NCO value 10.2%; viscosity of 1700 mPa·s at 25° C.) was prepolymerized with Hoopol® F931 (commercial polyester polyol) to NCO value of 3.0%.

42.5 g Hoopol® F931 was dried under vacuum at 100° C. and after cooling to 80° C., weighted into a reaction flask under nitrogen atmosphere. 57.5 g Suprasec® 2008 was added while blanketing with nitrogen and stirring vigorously. Temperature was maintained for 1.5 hours until a NCO content of 3.0% was reached with a monomeric di-isocyanate content of 4.1%.

Conclusion: the RHM based on a state of the art prepolymer with NCO value 10.2% (˜26% di-isocyanate) did not enable to achieve a monomeric di-isocyanate content <1%.

### 3) Example of the Invention: Reactive Hot Melt (RHM) Based on an Allophanate Based Polyisocyanate Intermediate Prepolymer

The allophanate intermediate is a prepolymer based on MDI and a monool (NCO value=10.7%; monomeric di-isocyanate content=15.9%; viscosity=2200 mPa·s at 25° C.; degree of allophanation: allophanate/urethane ratio=6.9) using Zn AcAc as allophanate initiating catalyst and thionyl chloride as deactivator.

This allophanate intermediate prepolymer was further polymerised with Hoopol® F931 (commercial polyester polyol) to NCO value of 1.5%.

71.0 g Hoopol® F931 was dried under vacuum at 100° C. and after cooling to 80° C., weighted into a reaction flask under nitrogen atmosphere. 29.0 g of the allophanate was added while blanketing with nitrogen and stirring vigorously. Temperature was maintained for 1.5 hours until a NCO content of 1.5% was reached with a monomeric di-isocyanate content of 0.4%.

Conclusion: the RHM based on an allophanate based prepolymer with NCO value 10.7% (˜15.9% di-isocyanate) enabled to achieve a monomeric di-isocyanate content <1.0%.

### 4) Example of the Invention: Reactive Hot Melt (RHM) Based on an Allophanate Based Polyisocyanate Intermediate Prepolymer

The allophanate intermediate is a prepolymer based on MDI and a monool (NCO value=10.7%; monomeric di-isocyanate content=15.9%; viscosity=2200 mPa·s at 25° C.; degree of allophanation: allophanate/urethane ratio=6.9) using Zn AcAc as allophanate initiating catalyst and thionyl chloride as deactivator.

This allophanate intermediate prepolymer was further polymerised with Hoopol® F931 (commercial polyester polyol) to NCO value of 1.0%.

75.5 g Hoopol® F931 was dried under vacuum at 100° C. and after cooling to 80° C., weighted into a reaction flask under nitrogen atmosphere. 24.5 g of the allophanate was added while blanketing with nitrogen and stirring vigorously. Temperature was maintained for 1.5 hours until a NCO content of 1.0% was reached with a monomeric di-isocyanate content <0.1%.

Conclusion: the RHM based on an allophanate based prepolymer with NCO value 10.7% (˜15.9% di-isocyanate) enabled to achieve a monomeric di-isocyanate content <0.1%.

### 5) Example of the Invention: Reactive Hot Melt (RHM) Based on an Allophanate Based Polyisocyanate Intermediate Prepolymer

The allophanate intermediate is a prepolymer based on MDI and a monool (NCO value=9.5%; monomeric di-isocyanate content=10.4%; viscosity=2040 mPa·s at 25° C.; degree of allophanation: allophanate/urethane ratio=1.9) using Zn AcAc as allophanate initiating catalyst and thionyl chloride as deactivator.

This allophanate intermediate prepolymer was further polymerised with Hoopol® F931 (commercial polyester polyol) to NCO value of 1.0%.

72.3 g Hoopol® F931 was dried under vacuum at 100° C. and after cooling to 80° C., weighted into a reaction flask under nitrogen atmosphere. 27.7 g of the allophanate was added while blanketing with nitrogen and stirring vigorously. Temperature was maintained for 1.5 hours until a NCO content of 1.0% was reached with a monomeric di-isocyanate content <0.1%.

Conclusion: the RHM based on an allophanate based prepolymer with NCO value 9.5% (˜10.4% di-isocyanate) enabled to achieve a monomeric di-isocyanate content <0.1%.

1. A urethane group-containing reactive polyisocyanate composition which contains not more than 1 wt % of monomeric starting di-isocyanate based on the total weight of said polyisocyanate composition, having an NCO value in the range 0.1-15%, and wherein said composition comprises urethane groups and allophanate groups and wherein the ratio of allophanate groups over urethane groups is between 0.05 and 100.

2. The reactive polyisocyanate composition according to claim 1, wherein the amount of monomeric starting di-isocyanate molecules is below 0.5 wt %, based on the total weight of said polyisocyanate composition.

3. The reactive polyisocyanate composition according to claim 1, wherein the NCO value is in the range 0.8-2%.

4. The reactive polyisocyanate composition according to claim 1, wherein the ratio allophanate groups over urethane groups is larger than 0.1.

5. A method to prepare the reactive polyisocyanate composition according claim 1, said method comprising mixing at least following compounds:
an allophanate based polyisocyanate intermediate prepolymer containing ≥0.1 wt % and ≤25 wt % of monomeric di-isocyanate compounds based on the total weight of said prepolymer and having an NCO value in the range 5-15%, and
an isocyanate reactive composition containing isocyanate reactive compounds having a functionality between 1 and 10 and a molecular weight in the range 100-10000, and
wherein the allophanate based polyisocyanate intermediate prepolymer is the reaction product of at least one polyisocyanate compound and an isocyanate reactive compound selected from a monool having a molecular weight in the range 32-2000 g/mol, preferably 36-2000 g/mol, and wherein the ratio of allophanate groups over the urethane groups is higher than 0.05.

6. The method according to claim 1, wherein the allophanate based polyisocyanate intermediate prepolymer contains ≥5 wt % and ≤20 wt % monomeric starting di-isocyanate compounds based on the total weight of said prepolymer.

7. The method according to claim 1, wherein the ratio of allophanate groups over the urethane groups in the allophanate based polyisocyanate intermediate prepolymer is in the range 1-100.

8. The method according to claim 1, wherein the allophanate based polyisocyanate intermediate prepolymer has an NCO value in the range 8-12%.

9. The method according to claim 1, wherein the monools are selected from polyoxyalkylene polyether monools, polyester monools and modified castor oil monools, having an average molecular weight of 32-1000 g/mol.

10. The method according to claim 1, wherein the polyisocyanate compounds used to make the polyisocyanate intermediate prepolymer are selected from diphenylmethane diisocyanate (MDI) based polyisocyanates having <40 wt % 2,4 MDI calculated on the total weight of the organic polyisocyanate mixture.

11. The method according to claim 1, wherein the isocyanate reactive compounds used to react with the allophanate intermediate prepolymer is having a functionality between 1.8 and 10.

12. The method according to claim 1, wherein the isocyanate reactive compounds used to react with the allophanate intermediate prepolymer are selected from the group comprising polyethers, polyesters, acrylic polyols, castor oil and modified castor oils, polybutadiene, polyolefin, or combinations thereof.

13. An allophanate based polyisocyanate intermediate prepolymer suitable for making the urethane group-containing polyisocyanate composition according to claim 1, said intermediate prepolymer is the reaction product a reactive composition comprising of at least one polyisocyanate compound and at least one isocyanate reactive compound selected from a monool having a molecular weight in the range 32-2000 g/mol and wherein the composition comprises: (i)
≥0.1 wt % and ≤25 wt % monomeric di-isocyanate compounds based on the total weight of said prepolymer;
(ii) an NCO value in the range 5-15%;
(iii) a ratio of allophanate groups over urethane groups higher than 0.05.

14. (canceled)
